(19) United States
(12) Patent Application Publication
(10) Pub. No.: US 2013/0270313 A1
(43) Pub. Date: Oct. 17, 2013

(54) TRUCK ROOF RACK

(71) Applicant: David Ekstrom, Sandy, UT (US)

(72) Inventor: DAVID EKSTROM, SANDY, UT (US)

(21) Appl. No.: 13/647,263

(22) Filed: Oct. 8, 2012

Related U.S. Application Data
(60) Provisional application No. 61/544,752, filed on Oct. 7, 2011.

(51) Int. Cl. B60R 9/045

(52) U.S. Cl. CPC B60R 9/045
USPC 224/282

(57) ABSTRACT

A roof rack that is configured with hinges and lifting shocks that allows the center basket to be lifted while still attached to the frame. Additionally, the roof rack can be used to mount lighting to the vehicle. Embodiments of the roof rack allow the roof of the vehicle to be accessed without removing the rack from the vehicle.

### CROSS-REFERENCE TO RELATED APPLICATIONS AND CLAIM OF PRIORITY

Priority of U.S. Provisional patent application Ser. No. 6,154,4752 filed on Oct. 8, 2012 is claimed.

### BACKGROUND OF THE INVENTION

This invention relates to a rack for attachment to a truck roof for holding baggage or other cargo. The object of the invention is to provide a rack that can be lifted to expose the roof of the truck and be access from the bed of the truck and a place to easily mount lighting. The truck roof can be exposed by lifting the center basket without removing the rack from the frame. The rack allows for the center basket to be completely removed and leave the truck lighting in place. The rack is attractive and sturdy and easily expands the cargo area of a truck.

### SUMMARY OF THE INVENTION

Embodiments of an apparatus are also described. In one embodiment, the apparatus is a roof rack comprising a frame configured to be connected to a vehicle roof with a center basket connected to the frame. A first hinge and a second hinge and a first lifting shock and a second lifting shock are used to connect the frame to the center basket. The first hinge and the second hinge and the first lifting shock and the second lifting shock are configures to allow the center basket to lift up from the frame and still be connected to the frame. Also, a means for securing the center basket such that the center basket cannot move up from the frame. Other embodiments of the apparatus are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a side view of the roof rack with the center basket lifted up.

FIG. 2 depicts a top view of the roof rack.

FIG. 3 depicts one embodiment of a side view of the roof rack.

Throughout the description, similar reference numbers may be used to identify similar elements.

### DETAILED DESCRIPTION

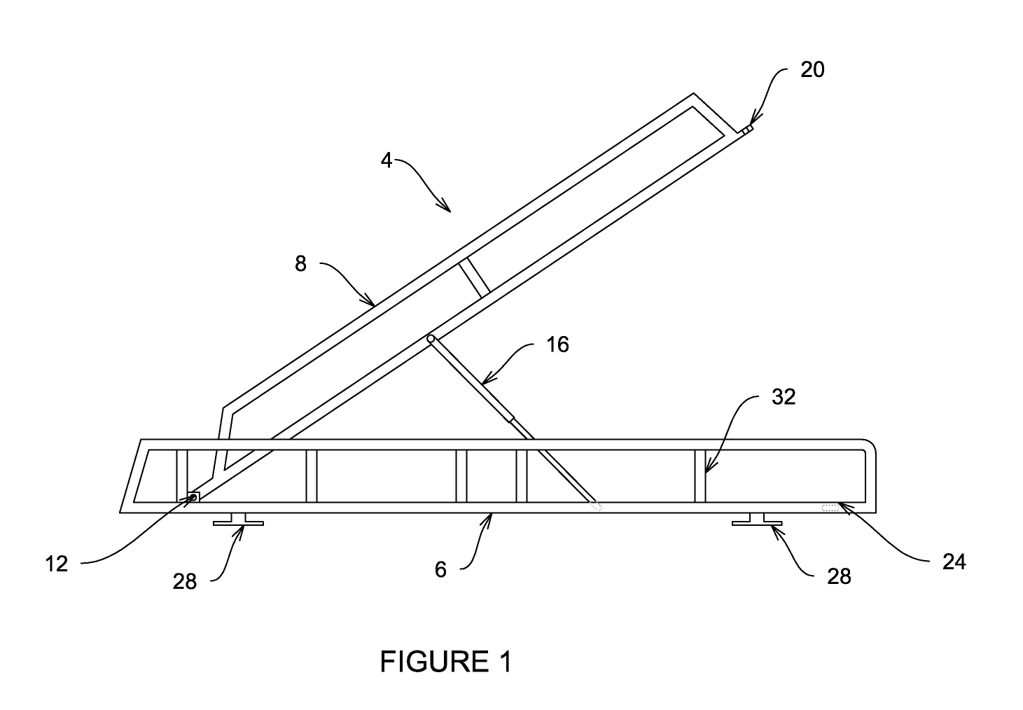

FIG. 1 depicts a side view of the roof rack with the center basket lifted up. Roof rack 4 comprises frame 6 and center basket 8. Center basket 8 is connected to frame 6 by hinge 12 and lifter shock 16 located on either side of frame 6. Safety handle 20 is secured to thread plate 24 by a threaded knob. Frame 6 is attached to the vehicle roof by attachment plates 28 located in both sides of the frame. The frame is attached to the vehicles strong points in the roof with stainless steel bolts. Cross bars 32 strengthens the frame.

Center basket 8 is lifted by removing the threaded knob from the thread plate 28 and the lifting shocks 16 lifting the basket to the up position shown in FIG. 1 thus allowing access to the vehicle roof. The lifting shocks 16 are strong enough to hold the center basket above the frame 6. Center basket 8 can be completely removed from frame 6 by removing hinge 12 bolts and lifter shock 16 bolts. This allows the frame to stay secured to the vehicle without the center basket 8. In one embodiment frame 6 and center basket 8 are construction from one inch tubing that has been welded and powered coated. In one embodiment the dimensions of the frame are six inches tall by seventy two inches long and fifty four inches wide. The center basket measures fifty eight inches long and forty five inches wide.

In one embodiment the frame 6 and center basket 8 are positioned one inch above the roof of the vehicle. This low profile keeps the overall height of the lower. Threading a threaded knob into thread plate 28 secures center basket 8 in place and prevents rattling while the vehicle is in motion. In one embodiment hinges 12 are located at the front of the vehicle.

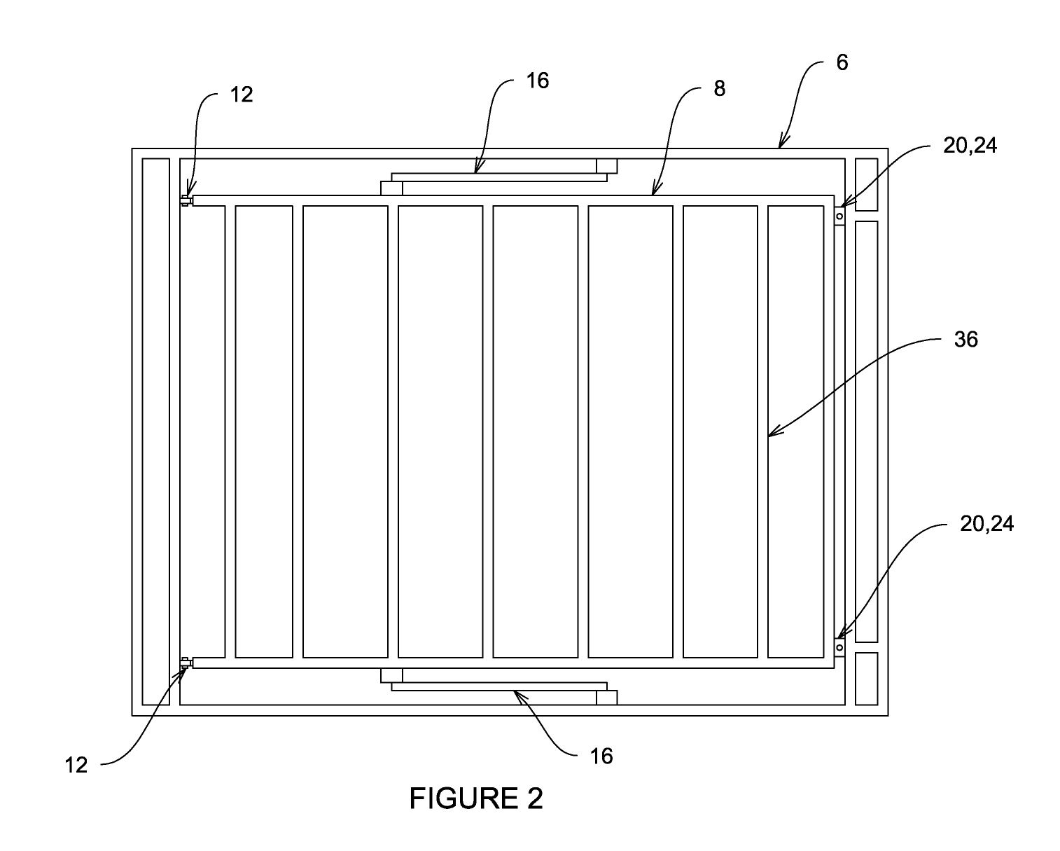

FIG. 2 depicts a top view of the roof rack. Cross bars 36 allow cargo to be placed on roof rack without touching the roof of the truck.

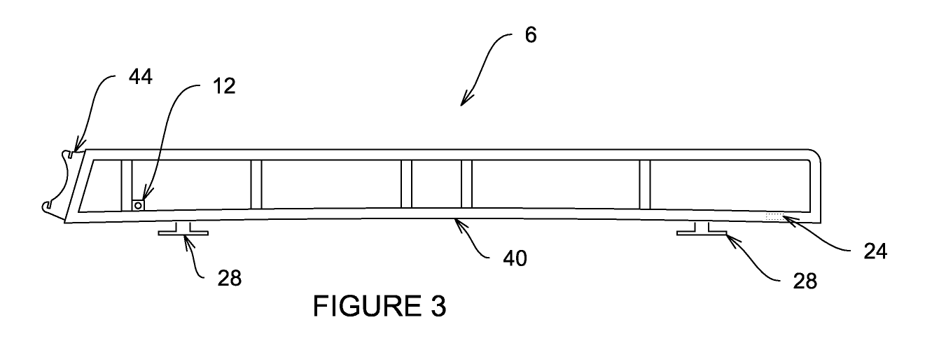

FIG. 3 depicts one embodiment of a side view of the roof rack. Bottom bar 40 is contoured to fit the shape of the vehicle roof. Lighting tab 44 allows custom lights to be placed on the roof rack and provides addition functionality.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A roof rack comprising:
a frame configured to be connected to a vehicle roof;
a center basket connected to the frame by a first hinge and a second hinge and a first lifting shock and a second lifting shock wherein the first hinge and the second hinge and the first lifting shock and the second lifting shock are configured to allow the center basket to lift up from the frame and still be connected to the frame; and
a means for securing the center basket such that the center basket cannot move up from the frame.

2. The roof rack of claim 1 wherein the means for securing the center basket is a threaded knob with a first threaded tab connected to the frame and a second threaded tab connected to the frame wherein the threaded knob is threaded into the first threaded tab and the second threaded tab.

3. The roof rack of claim 1 further comprising a lighting tab used for mounting lights to the frame.

4. The roof rack of claim 1 wherein the frame and the center basket are rounded to match a shape of the vehicle roof.

5. The roof rack of claim 1 wherein the first lifting shock and the second lifting shock are configure to push the center basket up from the frame and hold the center basket in place above the frame.

6. The roof rack of claim 1 wherein the center basket is configure to be removed from the frame while the frame is attached to the vehicle.

7. The roof rack of claim 1 wherein the roof of the vehicle is accessible from a rear of the vehicle when the basket is up from the frame.

8. The roof rack of claim 1 further comprising four attachment plates used to mount the frame to the vehicle.

9. The roof rack of claim 1 wherein the height of the frame is less than 8 inches above the vehicle roof.
